(19) United States
(12) Patent Application Publication
(10) Pub. No.: US 2004/0093227 A1
(43) Pub. Date: May 13, 2004

(54) Third party rental system

(76) Inventor: Michael Cho, Aurora, CO (US)

Correspondence Address: MICHAEL MORABE CHO, 4213 S SHAENEE CT, AURORA, CO, 80018, US

(21) Appl. No.: 10/291,569

(22) Filed: Nov. 12, 2002

(51) Int. Cl. G06F 17/60

(52) U.S. Cl. 705/1

(57) ABSTRACT

The invention is designed to maximize equipment/asset utilization while managing and limiting over-production and manufacturing. The invention provides a venue for equipment/s owner/lessor to rent/lease out their equipment/s to prospective lessor/renter. Equipment/s or Asset/s ranging from but not limited to automobiles, cranes, boats, planes, jet ski, camper home, timeshare, club memberships, tools, tractors, bulldozers, pavers, trailers, Bikes, Convertibles, Vans, Trucks, etc. The invention allows idle equipment to be put to work thru a third party that will assure smooth transaction. The invention seeks to provide the following services to enable lease/rental agreements between Owner/Lessor and Lessee/Renters: Brokerage, Agency, Insurance, Bond, Escrow, Guarantee, Waivers, Storage, Maintenance, Conflict Arbitration, etc. The invention will allow for Lessor/Owner and Lessee/Renters to book/reserve/lease/rent their Equipment/Assets in an efficient and secure manner.

### BACKGROUND AND SUMMARY OF THE INVENTION

The invention relates to creating a venue that is both physical and internet/web-based for Equipment/Asset owners to lease or rent-out their equipments/assets.

This system will enable efficient and gainful use of otherwise idle equipment/s. There will be a storage center/showroom facility for each metropolitan area, for the need, convenience and preference of involved parties. The invention intends to create value for under or un-utilized Assets/Equipment and maximize their utility. It was conceived based on the fact and notion that our natural resource is finite and that the current production-consumption model is inefficient. It creates a paradigm shift from productivity to utilization efficiency maximization. For renters/lessees it frees them from the burden of having to own. The Third Party Method will take care of ensuring equipment, advertising, safety laws & regulation compliance, provide insurance, qualify renters/lessee ability to pay, mediated conflicts, assure payment of lease and/or damages, provide maintenance, disclaimers, and take care other un-foreseeable issues. It borrows and merges the ideas from barter economy, capitalism, globalization, logistics, socialism, cooperatives, and environmentalism. The invention intends to commoditize accessibility to other third party owned property. I believe this invention will have a profound socioeconomic effect in the way we consume or utilize.

What is claimed is:

1. A method that will post, advertise, and broker available third party owned equipment/assets for rent/lease.

2. A method according to claim 1, wherein the possession, title, and ownership will be flexible and fluidly transferable between all parties involved and back, or ownership may even permanently change hands.

3. A method according to claim 1, wherein a physical storage lease-rental facility will be created to double as a storage facility for owners/lessors; and as a showroom for potential renters/lessees.

4. A method according to claim 1, wherein bonding, guarantee, insurance, checks, credit cards, or cash will be used to facilitate third party rental system.

5. A method according to claim 1, wherein a web based system will catalog and categorize available products by availability, price, value, location, product type, skill level required for potential renters
